(19) United States
(12) Patent Application Publication
(10) Pub. No.: US 2016/0252074 A1
(43) Pub. Date: Sep. 1, 2016

(54) VANE ASSEMBLY FOR A FLUID DYNAMIC MACHINE AND PROPULSION DEVICE

(71) Applicants: Miroslav NOVAK, Oponice (SK); SOLATRONIC INTERNATIONAL CORPORATION LIMITED, Hong Kong (CN)

(72) Inventor: Miroslav NOVAK, Oponice (SK)

(21) Appl. No.: 15/030,767

(22) PCT Filed: Oct. 22, 2014
(86) PCT No.: PCT/CN2014/089137

§ 371 Date: Apr. 20, 2016

(30) Foreign Application Priority Data
Oct. 22, 2013 (HK) 13111823.5

(51) Int. Cl. F03D 3/06; B63H 9/08; B63H 9/06; F03D 3/00; F03D 1/06

(52) U.S. Cl. CPC F03D 3/067; F03D 3/005; F03D 3/061; F03D 1/0666; F03D 1/0683; B63H 9/0607; B63H 9/08; F05B 2250/711; F05B 2250/712; F05B 2250/411

(57) ABSTRACT

A vane assembly, particularly suitable for a transverse flow, or vertical axis, turbine or a propulsion device includes a vane with at least one concavo-convex part that is mounted by a pivot so that it is free to rotate about a pivot axis. The pivot connects the vane to a rotor with an axis of rotation. The pivot axis is inclined to the concave face such that, as the rotor turns, the vane is free to rotate about the pivot axis between a first position in which the vane defines a high-drag configuration for retreating with a transverse fluid flow, and a second position in which the vane defines a reduced-drag configuration for advancing against the transverse fluid flow.

### TECHNICAL FIELD

The present invention relates generally to vane assemblies for fluid dynamic machines such as turbomachinery and particularly, but not exclusively, to wind and water-based turbines. The invention also relates to propulsion devices, such as for wind-driven apparatus like floating watercraft.

### BACKGROUND OF THE INVENTION

Much attention has been given to turbines for extracting useful energy from fluid flows, such as wind and tidal flows, and turbines for these application share many common features. A typical modern horizontal axis wind turbine (HAWT) has two or three slender blades oriented into the wind, which flows axially through the turbine. HAWTs characteristically rotate at velocities with tip speeds several times the wind speed, effectively presenting a disc to the wind. The blades are aerofoils with a high lift-to-drag ratio, and are driven through the air by aerodynamic lift. The aerofoil sections are specially designed to delay the onset of stall to further improve efficiency.

Turbines of another class use the aerodynamic drag forces pushing on flat or cupped vanes to turn a rotor and, advantageously, by orienting the axis of the rotor upright the flow is transverse, and a vertical axis wind turbine (VAWT) has no need of a device to orient the rotor to the wind direction. The theoretical maximum amount of useful energy that can be extracted from a given air flow is lower for drag based machines relative to lift based machines, but their advantages make them particularly suited to some niche applications. Their ability to operate in a wider range of wind speeds, constantly shifting wind direction and more turbulent wind conditions compared to horizontal axis rotors makes them well suited for use in urban environments, where VAWTs can be better integrated in building designs. Their relatively lower rotational speed can improve safety and reduce noise and vibration. Importantly, a VAWT may be well suited to coping with up-flows, such as commonly occur at the edge of buildings.

Inventors have come up with a number of ways for improving the efficiency of rotors that rely primarily upon drag. An example is the Savonius S-shaped cross-section rotor in which recirculating air flow between the two halves of the rotor provides a significant improvement. Another approach has been to use self-orienting vanes that orient themselves relative to the wind, without a separate control means, in a manner that improves performance. For example, U.S. Pat. No. 5,525,037 describes a VAWT where the vanes are mounted to the rotor by radially aligned hinges. The vanes are perpendicular to the airflow when moving downwind for maximum drag, and then the airflow causes them to rotate about the hinges through 90° to a low drag, flat shape when moving upwind. However, stops are required to limit the rotation of the vanes at their two ends, and the vanes oscillate back and forward between the stops, highly stressing the vanes and creating noise.

One of the major expenses for wind turbines in general is the ongoing maintenance costs, which occur after the turbine has been constructed and put into operation. Mundane causes include weathering and wear during normal operation. Wear can significantly increase for operating conditions outside the design envelope of the turbine. HAWTs require specific orientation of the turbine into the wind not only for optimization issues, but to minimize unsteady forces that are produced as the machine is yawed with respect to the wind. In some instances, active dynamic pitch control methods are used. However, the increasingly complex designs and subsequent maintenance costs can become high. This is another reason why passive dynamic pitch control systems are advantageous.

The power characteristics of the VAWT, providing features such as the ability to regulate the output or match the turbine output to a load, have also been addressed in a number of different ways in the past. WO2011044130 describes a self-regulating rotor like the Savonius S-shaped cross-section rotors, where the cups can pivot between open and closed positions for regulating power output. However, it is disadvantageous to have such a complicated and costly mechanism for vane control.

Furthermore, there is an ongoing need for improvements in efficiency, power characteristics and construction cost-effectiveness for fluid dynamic machines. Reference herein to “fluid dynamic machines” broadly refers to machines in which a working member such as a vane pushes on, or is pushed on, by a fluid. This term includes turbomachines, such as fans, blowers, compressors and pumps, as well as propulsion devices such as wind-driven propulsion devices for ships. It is an object of the present invention to address the above needs, to overcome or substantially ameliorate the above disadvantages or, more generally, to provide an improved turbomachine and propulsion device.

### DISCLOSURE OF THE INVENTION

According to one aspect of the present invention, there is provided a vane assembly for a transverse flow turbine, or other fluid dynamic machine, the vane assembly comprising: a rotor having an axis of rotation; at least one vane with at least one concavo-convex part having a concave face and an opposing convex face; a pivot connecting the vane to the rotor, the pivot having a pivot axis inclined to the concave face such that, as the rotor turns, the vane is free to rotate about the pivot axis between a first position in which the vane defines a high-drag configuration for retreating with a transverse fluid flow, and a second position in which the vane defines a reduced-drag configuration for advancing against the transverse fluid flow.

Preferably, the concavo-convex part is developable, the pivot axis is inclined at a first angle to a straight line on the concave face; the pivot axis and the straight line lie in a pivot axis plane that makes a dihedral angle of 15° or less, with an axial-tangential plane of the rotor that rotates with the vane about the axis of rotation, and both the first angle and a second angle between the pivot axis and the axis of rotation are between 30° and 60°.

Preferably, the dihedral angle is substantially 0°; both the first angle and the second angle are substantially 45°; the straight line is substantially parallel and perpendicular to the axis of rotation in the first and second positions respectively; and the vane is free to rotate substantially 180° about the pivot axis between the first and second positions.

Preferably, the vane is free to rotate 360° about the pivot axis, and no stops are provided to limit vane rotation.

Preferably, the axis of rotation is substantially upright, a leading end of the pivot axis is above a trailing end of the pivot axis; and in the first position the vane hangs below the pivot axis.

A pivot generally may comprise a round part received to turn in a complementary locating part, and may be, for instance, of the hinge type. Preferably, the pivot comprises at least one bearing for supporting the vane to rotate with low friction and many different well-known types of bearing could of course be used for this purpose. For instance the pivot may comprise a plain bearing, rolling element bearing or magnetic bearing, et cetera, with the bearing receiving a pivot shaft that is generally coaxial with the pivot axis, allowing the vane to rotate freely.

Optionally, the rotor comprises a hub defining the axis of rotation; and the pivot is offset from the hub.

Preferably, the concavo-convex part comprises at least one right half-cylinder having a cylindrical portion axis disposed in the pivot axis plane; wherein the vane has a substantially reflective symmetry about the pivot axis plane.

Preferably, the pivot axis intersects or passes proximate an axial end of the concavo-convex part.

Preferably, the vane further comprises at least one substantially flat fin portion aligned generally parallel with the pivot axis plane; the at least one fin portion projecting from the concave and/or the convex face of the concavo-convex part of the vane.

Preferably, the at least one fin portion projecting from the convex surface of an outermost one of the cylindrical portions is pointed.

Preferably, the at least one fin portion forms a spine of the vane that extends parallel to the pivot axis.

Preferably, the vane further comprises a counterweight eccentric to the pivot axis to counterbalance the mass of the vane. For instance, the counterweight may have a centre of mass generally disposed in the pivot axis plane on an opposite side of the pivot axis to a centre of mass of the vane.

Preferably, the pivot axis is inclined to the axis of rotation such that, with the axis of rotation upright, the concavo-convex part is downwardly concave in the second position.

The vane may comprise a plurality of concavo-convex parts, wherein each of the concavo-convex parts are of like form and are arrayed symmetrically about the pivot axis plane in one or more parallel linear rows, wherein the straight lines on each concave face of each concavo-convex part are substantially parallel to each other.

Preferably, the spacing along the pivot axis between adjacent concavo-convex parts is regular, most preferably substantially equal.

The rotor may comprise two rotor rings of like diameter, coaxial with the axis of rotation and fixed to one another at axially spaced positions, and wherein the pivot comprises a pivot shaft that extends between the rotor rings.

According to another aspect of the present invention, there is provided a propulsion device for a fluid-driven apparatus, the propulsion device comprising: at least one vane with at least one concavo-convex part having a concave face and an opposing convex face;

a pivot having a pivot axis inclined to the concave face such that, the vane is free to rotate about the pivot axis;

a mount on the fluid-driven apparatus to which the vane is attached by the pivot such that the pivot axis is inclined at an acute angle to an upright, and the vane is free to rotate about the pivot axis between a first position, in which a straight line on the concave face is substantially upright, and a second position, in which the straight line is substantially horizontal.

Preferably, the concavo-convex part is developable, the pivot axis is fixed relative to the fluid-driven apparatus, a first angle exists between the pivot axis and a straight line on the concave face; the pivot axis and the straight line lie in a pivot axis plane that makes a dihedral angle of 15° or less, with an upright plane, and both the first angle and a second angle between the pivot axis and the upright are between 30° and 60°.

Preferably, the dihedral angle is substantially 0°; both the first angle and the second angle are substantially 45°; and the vane is free to rotate substantially 360° about the pivot axis.

Preferably, the fluid-driven apparatus comprises a wind-driven apparatus, such as a floating watercraft or a wheeled vehicle, and the pivot axis plane is aligned longitudinally, and the pivot axis rises toward the forward end.

Preferably, the pivot axis is inclined to the upright such that the concavo-convex part is downwardly concave in the second position.

According to yet another aspect of the present invention there is provided vane assembly or propulsion device substantially as hereinbefore described with reference to the accompanying drawings.

The present invention provides a vane assembly for a fluid dynamic machine, particularly a turbine for wind or water applications which is effective and efficient in operational use, which may be economically constructed and has an overall simple design which minimizes manufacturing costs and maximizes performance. Pivoting the vane in the manner of the invention varies the effective area of the vane projected into an axial-radial plane, between a maximum when the cylindrical portion axis is substantially parallel to the axis of rotation and a minimum when the cylindrical portion axis is substantially perpendicular to the axis of rotation, and has been found to provide advantageous self-regulating properties, as well as other improvements.

### BRIEF DESCRIPTION OF THE DRAWINGS

Preferred forms of the present invention will now be described by way of example with reference to the accompanying drawings, wherein:

FIG. 1 is a schematic pictorial view of a vane assembly according to one embodiment of the present invention;

FIG. 2 is a simplified schematic view of the vane assembly of FIG. 1, showing the axial-tangential and axial-radial planes relative to a pitch cylinder;

FIGS. 3 and 4 are auxiliary end and side views respectively of views of the pitch cylinder and axial-tangential plane of FIG. 2, when rotated about axial and tangential axes respectively;

FIG. 5 is an axial end view of the vane of the vane assembly of FIG. 1;

FIG. 6a is a sectional view along AA of FIG. 5;

FIG. 6b is a schematic perspective view of a vane having a stabilising fin portion;

FIG. 7 defines the Cartesian (x, y, z) and cylindrical (r, θ, z) coordinate systems of the vane assembly of the present invention;

FIG. 8 is a plot of the circumferential velocity variation as a function of circumferential angle for various wind inflow velocities and rotational velocity ωR_{NT}=0.5 for the vane assembly of the present invention;

FIG. 9 is a plot of the radial velocity variation as a function of circumferential angle for various wind inflow velocities and rotational velocity ωR_{NT}=0.5 for the vane assembly of the present invention;

FIG. 10 is a plot of the circumferential velocity variation as a function of circumferential angle for Vₓ=1.0 wind inflow velocity and rotational velocities ωR_{NT}=0.5, 1.0 and 1.5 for the vane assembly of the present invention;

FIG. 11 is a plot of the radial velocity variation as a function of circumferential angle for Vₓ=1.0 wind inflow velocity and rotational velocities ωR_{NT}=0.5, 1.0 and 1.5 for the vane assembly of the present invention;

FIG. 12 defines the velocity magnitude and effective flow angle (β) for the vane assembly of the present invention;

FIG. 13 is a plot of the velocity magnitude variation over the rotational cycle for Vₓ=1.0 wind inflow velocity and rotational velocities ωR_{NT}=0.5, 1.0 and 1.5 for the vane assembly of the present invention;

FIG. 14 is a plot of the effective flow angle (β) over the rotational cycle for Vₓ=1.0 wind inflow velocity and rotational velocities ωR_{NT}=0.5, 1.0 and 1.5 for the vane assembly of the present invention;

FIG. 15 defines the local vane coordinate system for the vane assembly of the present invention;

FIG. 16 is a plot of the tilt angle, η, vs. rotation angle about the pivot axis, γ for the vane assembly of the present invention;

FIG. 17 is a plot of the variation of η (tilt angle) over the rotational cycle for Vₓ=1.0 wind inflow velocity and rotational velocities ωR_{NT}=0.5, 1.0 and 1.5 for the vane assembly of the present invention;

FIG. 18 is a schematic pictorial view of a machine according to a second embodiment of the invention;

FIG. 19 is a schematic pictorial view of a machine according to a third embodiment of the invention;

FIG. 20 is a schematic pictorial view of a machine according to a fourth embodiment of the invention;

FIG. 21 is a schematic pictorial view of a machine according to a fifth embodiment of the invention, and

FIG. 22 is a schematic pictorial view of a propulsion device according to one embodiment of the invention.

### DESCRIPTION OF THE PREFERRED EMBODIMENTS

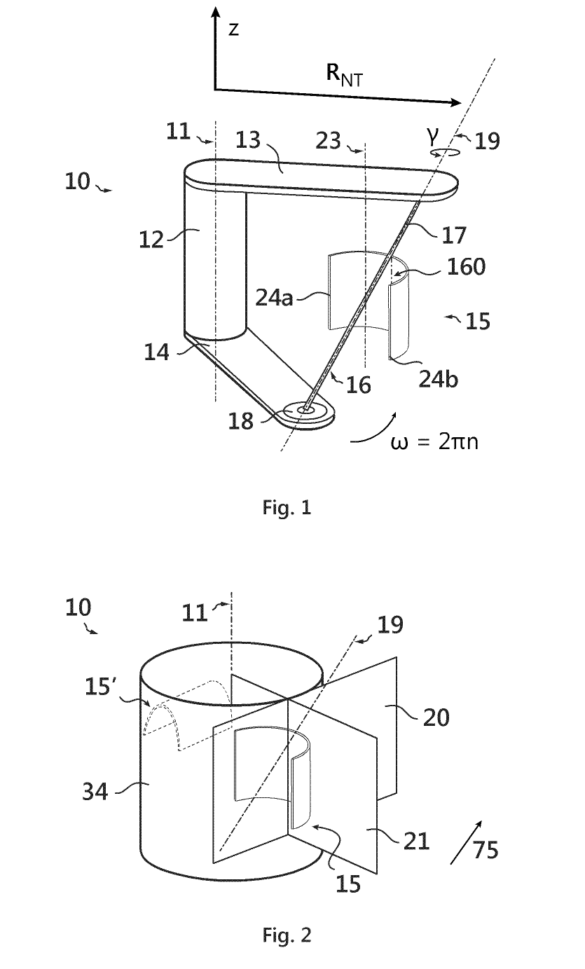

Referring to FIG. 1 of the drawings, there is shown a vane assembly for a turbine, particularly a wind turbine, having a rotor 10 with an axis of rotation 11 which may be upright. The rotor 10 may have a hub 12 coaxial with the axis of rotation 11, and spokes 13, 14, or the like, fixed to the hub 12 for carrying a vane 15. A pivot 16 may include a pivot shaft 17 having its opposing ends supported in bearings 18, which may be fixed to the spokes 13, 14. The vane 15 is thereby free to rotate 360° about the pivot axis 19 and, for instance, may be fixed to the pivot shaft 17 so that the vane 15 and pivot shaft 17 rotate together. The vane 15 is illustrated in FIG. 1 at an orientation in which the vane 15 is in a first position. For the purposes of the mathematical model of the movement below, the vane 15 is considered to rotate about the axis 11 at a radius (R_{NT}) with a rotational velocity, n (Hz), and angular frequency, ω (rad/sec).

Features of the vane assembly of the invention are described with reference to the axis of rotation 11, and unless the context implicitly or explicitly requires reference to a different axis, then as used herein, the term “axial” refers to a direction substantially parallel to the axis of rotation 11. Likewise, the term “radial” refers to a direction substantially orthogonal to the axis of rotation 11. The term “circumferential” refers to the direction of a circular arc having a radius substantially orthogonal to the axis of rotation 11. The term “tangential” refers to the direction tangential to a circular arc having a radius substantially orthogonal to the axis of rotation 11. As is conventional, the angle between two given lines is referred to as the angle between two intersecting lines which are parallel respectively to the two given lines, and the angle between two intersecting lines as the smallest angle between them. Consistent with these terms, and with reference only to the axis of rotation 11, the rotor 10 may define two mutually orthogonal rotating reference planes shown in FIG. 2: an axial-tangential plane 20 and an axial-radial plane 21. FIG. 2 illustrates the axial-tangential plane 20 and axial-radial plane 21 relative to a nominal circular vane path extended to a vane path cylinder 34 representing a nominal vane path of the vane 15 as it rotates about the axis of rotation 11.

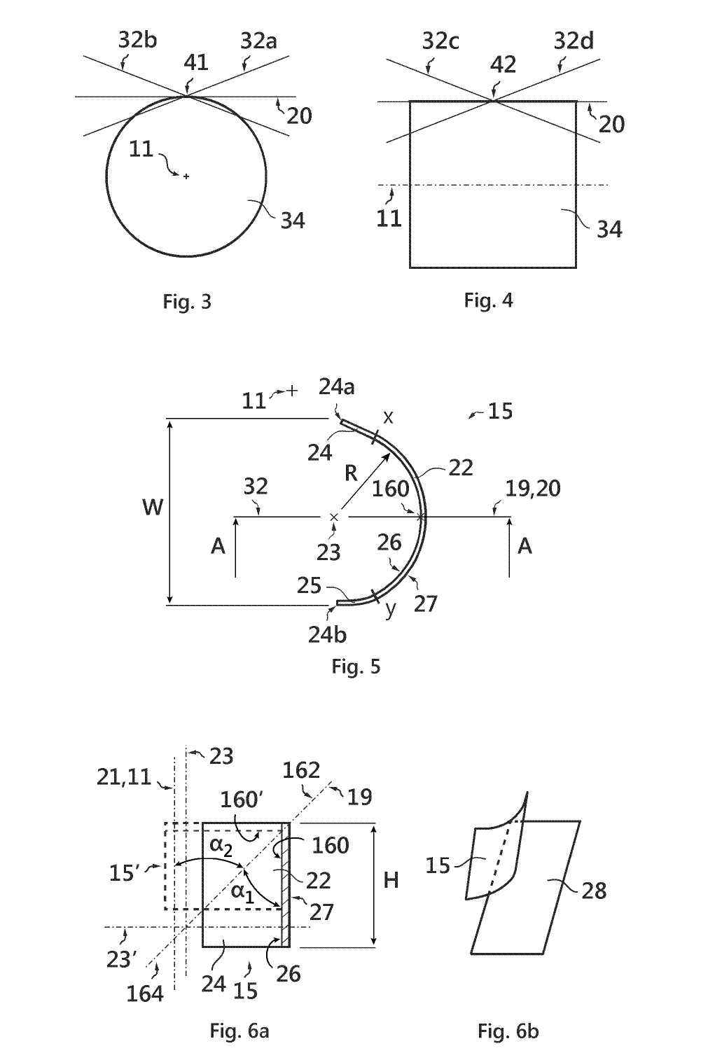

As presented in FIGS. 2-4, the pivot axis 19 rotates about the axis of rotation 11, but is maintained at a fixed inclination relative to the axis of rotation 11 and lies in a (rotating) pivot axis plane 32. For optimal performance, the pivot axis plane 32 is an axial-tangential plane 20 aligned tangentially (i.e. the pivot axis plane 32 makes a 0° dihedral angle with the axial-tangential plane 20) and so the pivot axis 19 and axis of rotation 11 do not intersect. The vane 15 is free to rotate about the pivot axis 19 and through an angle γ (as shown in FIG. 1 angle) γ=0°). However, satisfactory performance of the vane assembly can be obtained when the pivot axis plane 32 is inclined, as at about ±15° to the axial-tangential plane 20. FIGS. 3 and 4 show that the pivot axis plane 32 may be a plane inclined at any angle between the planes 32a, 32b and/or between the planes 32c, 32d. Planes 32a, 32b are inclined about an axial axis 41 at a dihedral angle of at most 15° to either side of the axial-tangential plane 20, and planes 32c, 32d are inclined about a tangential axis 42 at a dihedral angle of at most 15° to either side of the axial-tangential plane 20.

As shown in FIGS. 5 and 6, the vane 15 has a concavo-convex part with opposing concave and convex surfaces 26, 27 which may be separated by a constant dimension defined by the thickness of the vane material. The vane 15 may include a cylindrical portion 22 with a cylindrical portion axis 23 eccentric to the axis of rotation 11, with its concave surface having a radius of curvature R. The vane 15 may be elongated in the direction of the cylindrical portion axis 23, parallel to a straight line 160 on the concave face 26 that intersects with the pivot axis plane 32. The pivot axis plane 32, in which the pivot axis 19, the straight line 160 and the cylindrical portion axis 23 lie, bisects the vane 15, and may be perpendicular to the cylindrical portion 22. In addition to the cylindrical portion 22, the concavo-convex part may include, for instance, portions extending tangentially from opposite sides of the cylindrical portion 22 such as a planar, rectangular portion 24 tangential to the cylindrical portion 22 at the plane X of intersection. The vane 15 may further include a cylindrical portion 25 tangential to the cylindrical portion 22 at plane Y. The rectangular portion 24 and cylindrical portion 25 may have linear, parallel edges 24a, 24b. It is preferred that the vane 15 has a non-reentrant shape such as best seen in FIG. 5, where the edges 24a, 24b of the cylindrical portion 25 and rectangular portion 24 are either divergent, or else where the two opposing edges of the concavo-convex part are parallel (as is the case in a half-ellipsoid or half-cylinder). The vane 15 may be oriented with respect to the axis of rotation 11 such that in the first position the parallel edges 24a, 24b lie in a radial plane, and the pivot axis plane 32 is aligned tangentially. The shape of the concavo-convex part 22, 24, 25 should be developable, i.e. a shape with zero Gaussian curvature that can be formed from a sheet by bending about one axis without distortion.

FIG. 6a (like FIG. 1) illustrates the vane 15 in the first position, in which the straight line 160 on the concave face 26 is oriented parallel to the axis of rotation 11. The designation prime (′) is used to show the second position of the vane, where it is shown in dashed outline indicated by 15′. In this second position the straight line 160 is substantially perpendicular to the axis of rotation 11.

The pivot axis 19 is inclined at a first angle α₁ of 45° to the straight line 160 and at a second acute angle α₂ of 45° to the axis of rotation 11. The vane 15 is rotated by an angle □=180° about the pivot axis 19 between the first and second positions, while it is simultaneously turned 180° about the axis of rotation 11. The pivot axis 19 may be inclined relative to the axis of rotation 11 such that with the axis of rotation 11 upright, the vane 15′ is downwardly concave in the second position i.e. the concave surface 26 faces downward. A leading end 162 of the pivot axis 19 is above a trailing end 164 of the pivot axis 19, and in the first position the vane 15 hangs below the pivot axis 19. The pivot axis 19 may intersect proximate an axial end of each vane 15 which is uppermost when the vane 15 is at rest. The geometry illustrated in the drawings thus comprises two important fixed angles, the first angle α₁ between the straight line 160 and the pivot axis 19, and the second angle α₂ between the pivot axis 19 and the axis of rotation 11, which are both preferably 45°.

The first and second positions shown in FIG. 6a are the static state boundary positions of the pivoting of the vane 15 about the pivot axis 19, and in these first and second positions the vane 15 presents to the airflow a maximum and minimum drag shape respectively. In the first position, the effective area of the vane 15 projected into an axial-radial plane 21 is rectangular, with dimension W×H, where it is a maximum, and the straight line 160 is parallel to the axis of rotation 11. In the second position of the vane 15′ the effective area of the vane 15 projected into the axial-radial plane 21 is a minimum, defined by the length of the arcuate edge of the vane shown in FIG. 5 and the distance between the concave and convex surfaces 26, 27. In this second position the straight line 160′ is perpendicular to the axis of rotation, extending in the tangential direction. Moreover, in the first position the vane 15 is retreating and presents a bluff, cupped, high-drag shape to the tangential air flow, while in the second position the vane 15 is advancing against the wind and a streamlined, low-drag shape is presented to the wind. All developable vane shapes will possess this property, owing to their geometry in which all points on the concave surface 26 lie on lines parallel to the straight line 160 and thus may be used in the present invention. While the first and second angles α₁, α₂ of 45° between the pivot axis 19 and the straight line 160, and between the pivot axis 19 and the axis of rotation 11, permit the rotation between a maximum and a minimum, it remains sufficient for a slightly less than optimal but still significant performance improvement, that the vane 15 is able to pivot between positions in which a near-maximum and/or a near minimum effective area projected into an axial-radial plane 21 are attained, as where the first and second angles α₁, α₂ are between about 30° and about 60°.

In addition to the concavo-convex part 22, 24, 25, at least one fin portion 28 (shown in FIG. 6b) may be provided on the vane 15, each being flat and aligned generally parallel with the pivot axis plane 32 that bisects the vane 15. The fin portion 28 may be fixed to the cylindrical portion 22, projecting from the convex surface 27, as shown, but may, alternatively or in addition, project from the concave surface 26. The fin portion 28 may be generally rectangular, but other shapes with straight edges may be used, as may closed shapes with one or more curved edges. As the aerodynamic moment centre of the vane is located at the quarter chord location, this feature causes the fin portion 28 to be aligned with the local wind direction. The fin portion 28 provides a stabilising function, tending to resist forces acting to rotate the vane 15 about the pivot axis 19 when the rotor 10 is turning.

In operation, the vane 15 may be oriented in first and second positions when on diametrically opposite sides of the rotor 10 as described above, where the tangential directions are aligned parallel with the wind direction 75. The vane 15 rotates freely under the applied forces between these positions without the need for any mechanism acting on the vanes 15, thus achieving passive dynamic pitch control. Without wishing to be limited by theory, when in the first position and instantaneously heading directly downwind the drag force pressing on the vane 15 applies a torque that has no component tending to rotate the vane 15 about the pivot axis 19, while as it retreats toward its most downstream position the torque does tend to rotate the vane about the pivot axis 19. The further the vane 15 rotates about the pivot axis 19 the greater the extent to which air is able to flow from the high to the low pressure side of the vane 15, providing a self-regulating property, that assists, for instance, in avoiding the generation of excessive torque in high winds. As the vane 15 passes its most downstream position, the fins portions 28, 29 may assist in feathering or further turning the vane about the pivot axis 19 as it starts to advance into the wind, and becoming fully feathered in the second position, before it then reverses rotation about the pivot axis 19, as the vane rotates again to the position (15′) where it is instantaneously heading directly downwind. Like a mainsail on a sailing boat properly trimmed for the direction of travel, the vanes 15 are oriented for maximum drag when going directly downwind, and are fully feathered for minimum drag when going directly upwind, and at all intermediate positions drag and lift forces combine to produce torque on the rotor 10. In this manner the rotor 10 is able to extract energy from a transverse wind, or horizontal wind when the axis 11 is upright, but advantageously it may also extract energy from an axial flow, such as when integrated into a building it can take advantages of up-flows and down-flows.

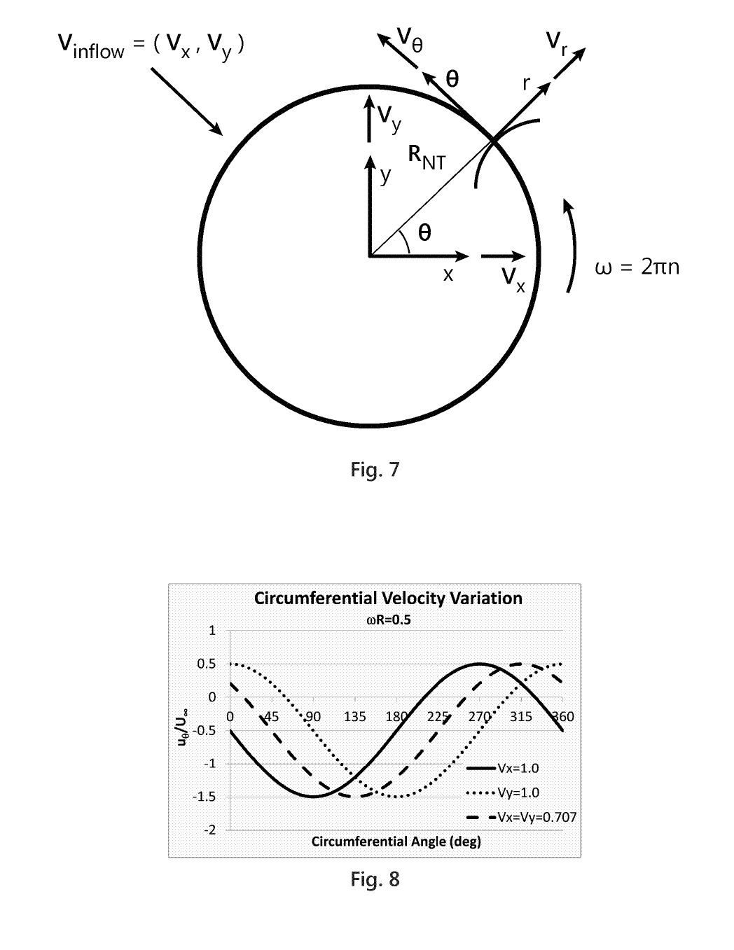

To mathematically model the rotation of the vane 15 a cylindrical and Cartesian coordinate system may be defined. The z-axis points up vertically and corresponds with the axis of rotation 11. A plane is defined by the x and y coordinates in such a way as to be consistent with a right hand coordinate system. A cylindrical coordinate system is convenient to best describe the local flow to the vane 15. The radial direction, r, is positive outward and the circumferential direction, θ, is positive to maintain a right-handed coordinate system. FIG. 7 shows the corresponding Cartesian (x,y,z) and cylindrical (r,θ,z) coordinate systems.

The turbine rotates with a rotational velocity, n (Hz), and angular frequency, ω(rad/sec). For a coordinate system that moves with the leading edge center of a single vane, the resultant velocity due to the rotational motion of the turbine may be described as:

Vᵣ=0,V_{θ}=−2πnR_{NT}=−ωR_{NT} (1)

where the subscripts r refers to the radial direction and θ refers to the circumferential direction. The θ velocity component is in a direction opposite the rotation as this is the velocity relative to the vane.

The total velocity at the vane leading edge center can then be described as:

Vᵣ=Vₓ cos(θ)+V_{y} sin(θ),V_{θ}=−ωR_{NT}−Vₓ sin(θ)+V_{y} cos(θ) (2)

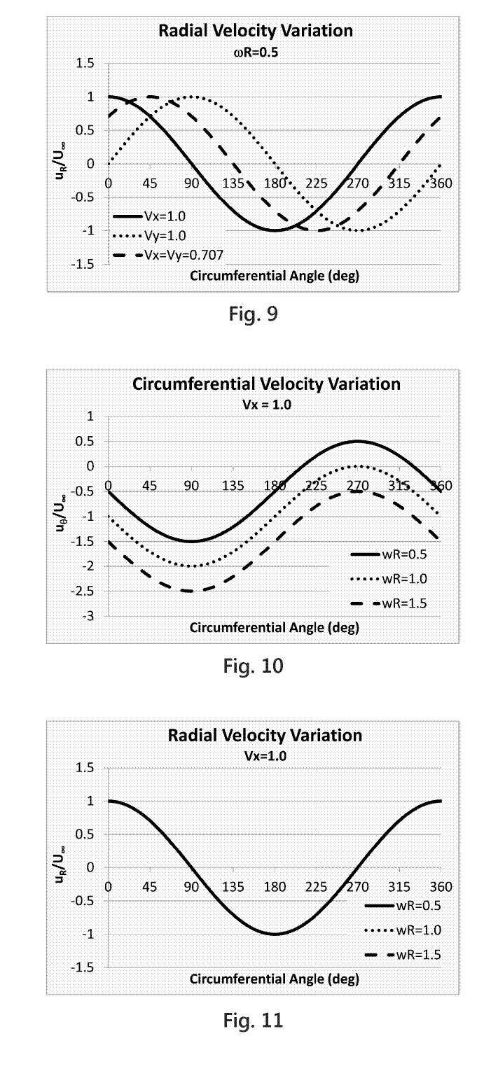

FIGS. 8 and 9 graphically represent the circumferential and radial velocity as a function of circumferential angular position for wind velocities Vₓ=1.0, V_{y}=1.0 and Vₓ=V_{y}=0.707 (velocity magnitude of 1.0 with rotational velocity (−ωR_{NT})=0.5. As can be seen in FIGS. 8 and 9, the circumferential variations are identical with the curves offset by a phase angle. As a vane assembly that automatically adjusts with and adapts to the wind direction, the vane assembly has an attractive feature that it is insensitive to the wind direction.

The circumferential velocity variation is plotted in FIG. 10 for the Vx=1.0 wind inflow velocity case and three different rotational velocities, (−ωR_{NT}=0.5, 1.0 and 1.5. As can be seen, for tip speed ratios (λ=V_{wind}(−R_{NT})) less than 1.0, positive and negative circumferential velocities are seen. For λ=1.0 the circumferential velocity becomes zero only once during the rotational cycle and for λ greater than one, the circumferential velocities are always negative.

The radial velocity variation is plotted in FIG. 11 for the same conditions as presented in FIG. 10. Since the radial velocity is affected only by the wind velocity and not the rotational velocity, the radial velocity variation is independent of the rotational velocity.

The circumferential and radial velocity components can be defined by a velocity magnitude (V_{mag}) acting on the vane surface at an effective flow angle (β). In this geometry, the effective flow angle due to wind and rotational velocities is defined as:

V_{mag}=\sqrt{Vᵣ²+V_{θ}²},β=atan(Vᵣ/(V_{θ}) (3)

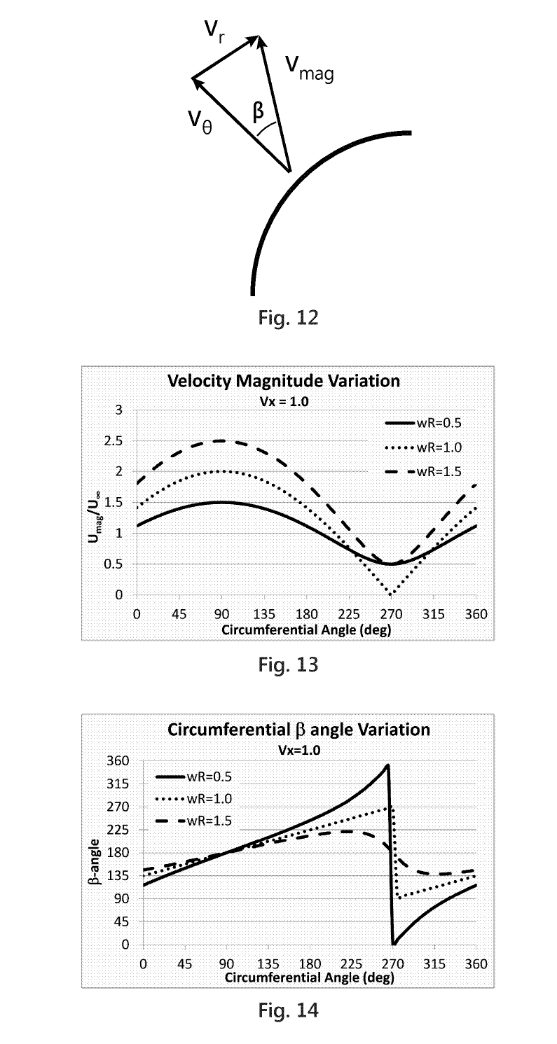

FIG. 12 depicts the geometric definition of β. The variation in velocity magnitude is shown in FIG. 13 for Vₓ=1.0 and the three rotational velocities of 0.5, 1.0 and 1.5. Unique behavior is seen for a tip speed ratio of 1.0 where the velocity magnitude becomes identically 0. For all other values of λ, non-zero velocity magnitudes are seen.

FIG. 14 presents the effective flow angle over a rotational cycle for Vₓ=1.0 and the three rotational velocities of 0.5, 1.0 and 1.5. For λ<1.0, there is a steady, non-linear variation in flow angle (the jump from 360° to 0° reflects a new rotational cycle). For λ=1.0, there is an abrupt change in flow angle at θ=270°, from 270 to 90°, due to the sign change in the radial velocity. Note that the flow angles are bounded by 90° and 270°. For λ>1.0, there will again be steady variations but the flow angles will be bounded by 90° and 270°. For a rotational velocity of 1.5, the maximum flow angle is 45°.

The velocity components of the wind may be characterized by x and y components. For a reference frame located at the leading edge center of a given vane 15, the corresponding velocity components are:

Vᵣ=Vₓ cos(θ)+V_{y} sin(θ),V_{θ}=−Vₓ sin(θ)+V_{y} cos(θ) (4)

wherein subscripts x and y refer to the wind velocity components and θ refers to the circumferential angular position.

The proposed machine in the present embodiment contains an additional degree of freedom. As stated, the vane assembly rotates about the central axis 11, and the individual vanes can rotate about a pivot axis 19. By design, this allows the vane to adjust to the varying wind direction as it rotates through the cycle. The angle which the vane rotates about axis 19 can be seen in FIG. 1 and is defined as γ. FIG. 6 shows a planar cut (r-z plane) of the turbine. The pivot axis 19 is oriented at an angle, α₂, relative to the axis of rotation 11. In addition, the vane is oriented to the pivot axis 19 at an angle, α₁. As the vane rotates by an angle, γ, the local angle of the flow to the vane will be affected as will be explained.

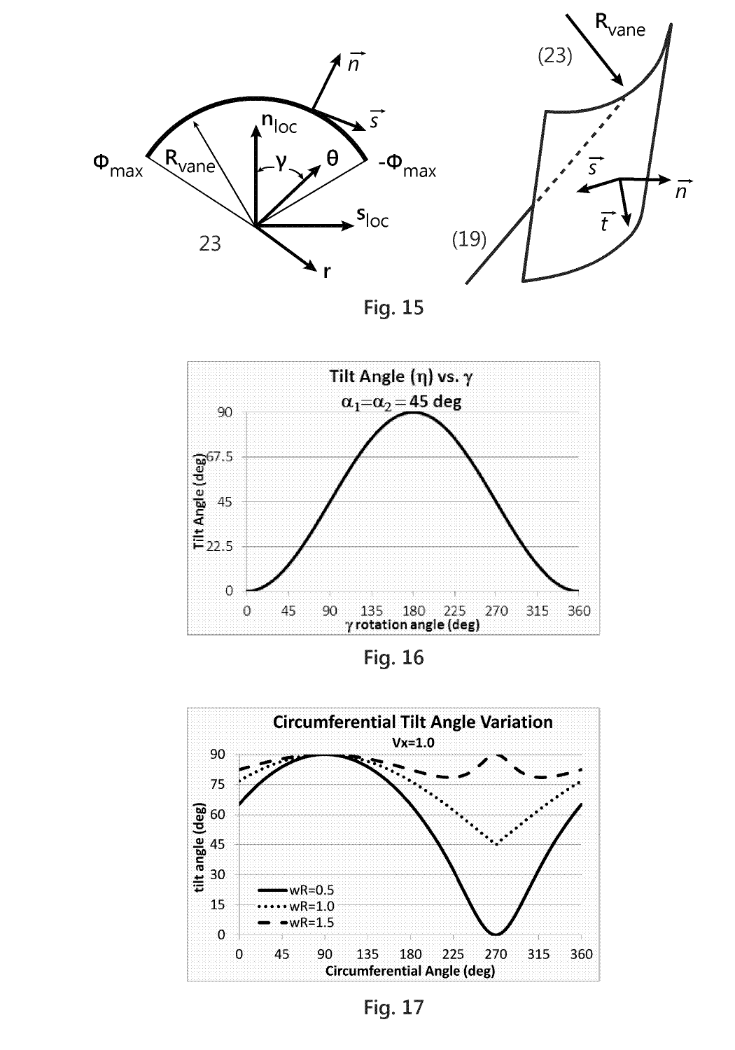

FIG. 15 shows a local vane coordinate system of the present invention. The local velocity at the vane surface is highly variable depending on the vane rotational angle, γ. First, a local coordinate system can be defined by normal (n) and orthogonal (s and t) coordinates. The local coordinate system follows the right hand rule. For a zero γ angle and for cases where α₁=α₂, the vane normal is aligned in the θ direction and the s coordinate is aligned in the radial direction. The t component is opposite the global z direction. As defined, the vane has a radius of curvature, Rᵥₐₙₑ, and is swept out by an angle of ±φₘₐₓ. If Rᵥₐₙₑ is small compared with the radius of the turbine, R_{NT}, the variation in normal velocity due to rotation may be ignored. Generally, this variation needs to be modified and may be approximated as:

V_{θlocal}=V_{θ}−ωRᵥₐₙₑ(sin(φ+γ)−sin(γ)),φₘₐₓ≦φ≦φₘₐₓ (5)

Note that both γ and φ follow the right hand rule and are positive counter-clockwise.

Due to the non-zero pivot angle, α₂, and the angle of the vane relative to the pivot axis, α₁, a vane tilt angle may be defined as η, and is dependent on the rotation of vane by the angle γ:

η=α₂−α₁ cos(γ) (6)

For cases where α₂=α₁, this expression can be simplified as:

η=α₂(1−cos(γ)) (7)

FIG. 16 shows the tilt angle, η, as a function of the rotation angle, γ, for the case where α₂=α₁=45°. For this case, the maximum tilt angle reaches 90° for a full 180° rotation of the vane.

The velocity field at any point on the front surface of the vane may now be described as:

Vₙ=[V_{θlocal} cos(γ+φ)+Vᵣ sin(γ+φ)] cos(η)

Vₛ=−V_{θlocal} sin(γ+φ)+Vᵣ cos(γ+φ)

Vₜ=[V_{θlocal} cos(γ+φ)+Vᵣ sin(γ+φ)] sin(η) (8)

Based on these flow velocities, local pitch, roll and yaw angles of the vane relative to the flow may be defined as follows:

pitch=atan(Vₙ/Vₜ),roll=atan(Vₛ/Vₜ),yaw=atan(Vₜ/Vₛ) (9)

The circumferential variation in γ is the same as the β angle and was plotted in FIG. 14 for rotational velocities of 0.5, 1.0 and 1.5. For this flow analysis, it is assumed that the vane instantaneously reacts to the local flow velocities. In real-world applications, there will be a delayed temporal response due to the moment of inertia of the structure. FIG. 17 presents the resultant tilt angles for the three rotational velocities. For the low rotation case (0.5), tilt angles vary between 0° and 90°. This would be typical for tip speed ratios less than 1.0. For a tip speed ratio of 1.0, the tilt angle remains below 45° due to the fact that the γ angles are bounded by 90° and 270°. For λ greater than 1, the tilt angles vary less so that for the case where the rotational velocities are 1.5, the tilt angle varies between 75° and 90°.

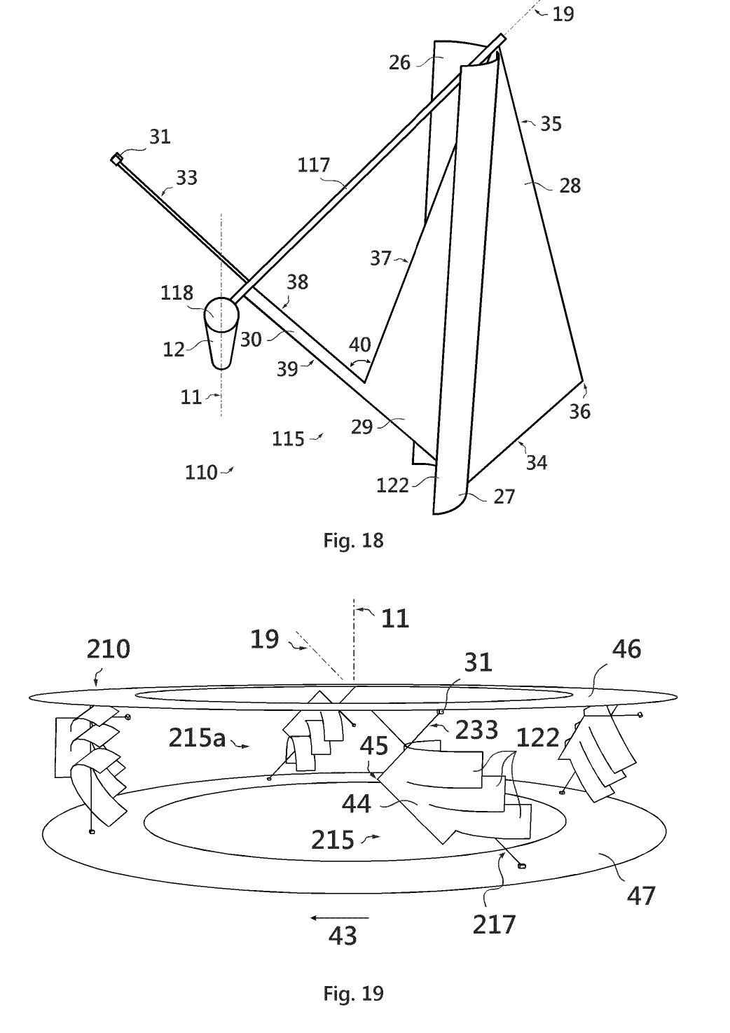

A second embodiment of the machine of the present invention is illustrated in FIG. 18, and corresponding numerals are used herein to reference like components. In this embodiment, the concavo-convex part of the vane 115 has the form of a right half-cylinder or a cylindrical portion 122. First and second fins 28, 29 may be generally coplanar, aligned generally in the bisecting plane 32 (not shown in FIG. 18) that equally bisects the half-cylinder 122 and in which the cylindrical portion axis 23 and straight line 160 lie. The first fin 28 may be triangular, and project from the convex surface 27 of the cylindrical portion 122, having edges 34, 35 extending from axially opposing ends of the half-cylinder 122 to meet at a point 36. The second fin 29 may project from the concave surface 26 of the cylindrical portion 122 and serve to connect the cylindrical portion 122 to the pivot shaft 117. The second fin 29 may also serve to connect the half-cylinder 122 to the pivot shaft 117, for instance, as by providing edges 37, 39 extending from axially opposing ends of the half-cylinder 122, an edge 38 generally parallel to edge 39 and intersecting edge 37 at an acute angle 40, so as to form a strip 30 fixed at its end to the pivot shaft 117. The first and second fins 28, 29 are formed from thin material, like the half-cylinder 122, and they provide a stabilising function, as they tend to resist forces acting to rotate the vane 115 about the pivot axis 19 when the rotor 110 is turning. The pivot shaft 117 may be supported at 45° to the axis of rotation 11 in a cantilevered manner, by a journal 118 mounted to the hub 12 which receives on end of the pivot shaft 117. In this embodiment the pivot axis 19 may thus intersect with the axis of rotation 11. A counterweight 31 may be provided, having its centre of mass generally disposed in the bisecting plane 32 on an opposite side of the pivot axis 19 to a centre of mass of the half-cylinder 122. The counterweight 31 may be fixed to the pivot shaft 117 by a bar 33. The counterweight 31 serves to mitigate some inertial effects that may otherwise tend to rotate the vane 115 in an unwanted manner about the pivot axis 19 when the vane 115 is turning.

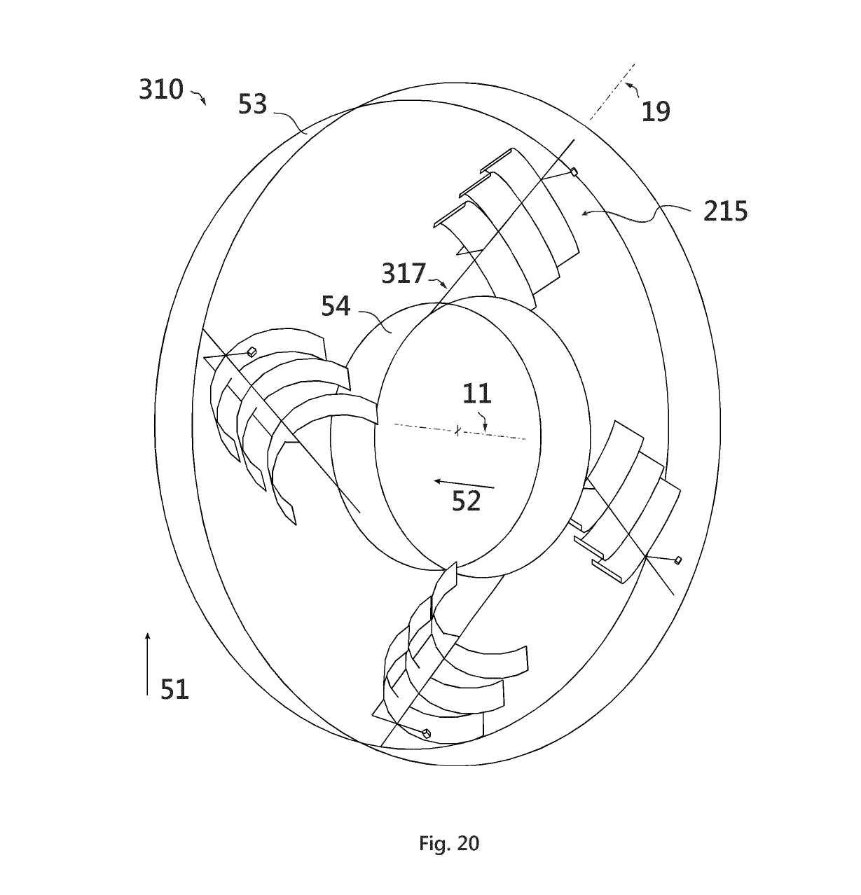

As per a third embodiment of the machine shown in FIG. 19, multiple concavo-convex half-cylinders 122 may be fixed together to form a vane 215. As shown in FIG. 19, four equally circumferentially spaced like vanes 215 are arranged in different orientations, as occurs in use with wind flow in direction 43. In this embodiment, each vane 215 is mounted for rotation about a respective pivot axis 19 inclined at 45° to the axis of rotation 11, with each half-cylinder 122 being oriented with respect to the pivot axis 19 in the same manner as described above, with an angle of 45° being provided between the pivot axis 19 and straight lines 60 on each of the concave faces of the half-cylinders 122.

The vane 215 may comprise like half-cylinder parts 122 arrayed symmetrically about the pivot axis plane in a linear row parallel to, and equally spaced from one another along the pivot axis 19, optionally overlapping one another, such that the effective area of the vane 15 projected into an axial-radial plane 21 is rectangular, with a width W and height somewhat less than 3×H according to the amount of axial overlap. The fin portions of the vanes 215 project from the convex side 27 are connected to form a spine 44 of the vane 215 that is elongated parallel to the pivot axis 19, and serves the same function as the fin 28. A fin portion projecting from the convex surface of the outermost half-cylinder 122 may have tapered edges 45. A single counterweight 31 may be provided, having its centre of mass generally disposed in the bisecting plane 32 on an opposite side of the pivot axis 19 to a centre of mass of the half-cylinders 122. The counterweight 31 may be fixed to the pivot shaft 217 or the fin by a bar 233.

A brake (not shown) may be provided to lock the pivot, to prevent rotation of the vane 215 about the pivot axis 19.

The rotor is hubless, and comprises two rotor rings 46, 47. The pivot comprises a pivot shaft 217 coaxial with the pivot axis 19 and connected at opposing ends to the rotor rings 46, 47, and permits free 360° rotation of the vane 215 about the pivot axis 19. The rotor rings 46, 47 are of like diameter, coaxial with axis of rotation 11 and fixed to one another at axially spaced positions. In the position illustrated in FIG. 19, the vane 215 is moving downwind in direction 43 and is in its first position, in which it projects the maximum area into the axial-radial plane 21 for high drag. The vane 215a diametrically opposite the vane 215 is in the second position, and has rotated (about the pivot axis 19) through 180° to the position shown, where the concave surfaces of the half-cylinders 122 face downward, and the vane 215a presents a minimum drag form to the airflow 43 as it moves directly upstream.

FIG. 20 illustrates a vane assembly of an axial flow wind turbine that rotates in direction 51 with generally axial airflow 52. Multiple circumferentially spaced like vanes 215 are mounted to the vane assembly 310, in a similar manner to the embodiment of FIG. 19, in as far as they are supported for rotation about the pivot axis 19 of a pivot shaft 317 that spans between coaxial rotor rings 53, 54. The outer rotor ring 53 is of larger diameter than inner rotor ring 54 and these rings 53, 54 fixed to one another to rotate together at axially spaced positions. Each pivot axis 19 is inclined at 45° to the axis of rotation 11, and the straight lines 60 are at 45° to the pivot axis 19 of each vane 215, however, in this embodiment the pivot axis 19 of each of the vane 215 lies in a plane (not shown) inclined about a radial axis (not shown) at 45° to the axial radial plane 21. In such an axial flow turbomachine (e.g. turbine or blower) an orthogonal projection of the pivot axis 19 onto the pivot axis plane 32 (i.e. orthogonal to the pivot axis plane 32) may be inclined at ±45° to the axial-radial plane 21.

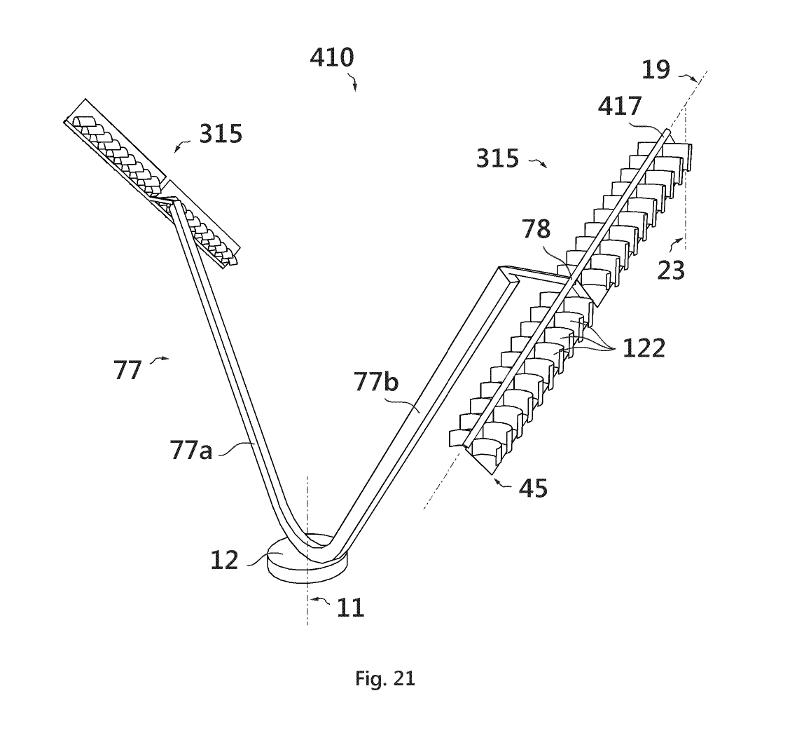

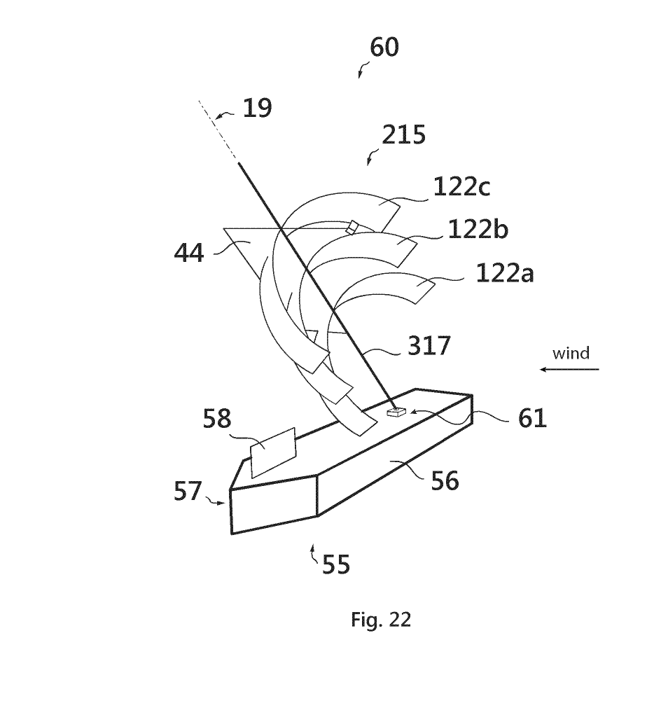

In a fifth embodiment of the machine of the present invention as illustrated in FIG. 21, two diametrically opposite vanes 315 are provided, each mounted on leg 77a, 77b of a V-shaped support 77, fixed to the hub 12. Each vane 315 is likewise mounted for rotation about a respective pivot axis 19 supported at 45° to the to the axis of rotation 11, with each half-cylinder part 122 oriented with respect to the pivot axis 19 such that an angle of 45° is provided between a straight line 160 (on the concave surface of the half-cylinder parts 122) and the pivot axis 19. The vane 315 may comprise twenty like half-cylinder parts 122 arrayed symmetrically about the pivot axis plane in two parallel rows disposed symmetrically either side of the pivot axis plane 20 and parallel to, and equally spaced along the pivot axis 19, but overlapping one another. Although twenty half-cylinder parts 122 are provided on each vane 315, but due to the overlap so that the effective rectangular area of the vane 315 projected into an axial-radial plane 21 is, has a dimension of less than 20×W×H, when in the first position. An intermediate part 78 of the pivot shaft 417 is fixed to the end of each leg 77a, 77b with half of the half-cylinder parts 122 disposed either side of the intermediate part 78. The fin portions of the vanes 315 projecting from the convex sides 27 are connected to form a spine 44 of the vane 215 that is elongated parallel to the pivot axis 19 between the two rows. A fin portion projecting from the convex surface of the outermost half-cylinder 122 is tapered to a point 45. Counterweight is not shown on the picture. Alternatively, no counterweight is provided.

A vane 15, 115, 315 or, a vane 215 as shown in FIG. 22, may be mounted to floating watercraft 55 having a hull 56 with a forward end 57. An imaginary central upright plane 58 bisects the hull 56 longitudinally, and the pivot axis 19 lies generally in the upright plane 58, inclined upward toward the forward end 57 at about 45° to an upright. As when mounted on a rotor, the vane 15, 115, 315 or the vane 215 is free to rotate about the pivot axis 19 in the wind, and an angle of 45° exists between the pivot axis 19 and straight lines 60 on the concave faces of the vanes, thereby providing a propulsion device 60 for the watercraft 55. A mounting assembly 61 may connect the end of the pivot shaft 317 to the hull 56. The vane 215 may be fixed to rotate with the pivot shaft 317 and the mounting assembly 61 may include a brake (not shown) for preventing rotation of the vane 215.

Aspects of the present invention have been described by way of example only and it should be appreciated that modifications and additions may be made thereto without departing from the scope thereof.

1. A vane assembly for a transverse flow turbine, or other fluid dynamic machine, the vane assembly comprising:
a rotor having an axis of rotation;
at least one vane with at least one concavo-convex part having a concave face and an opposing convex face; and
a pivot connecting the vane to the rotor, the pivot having a pivot axis inclined to the concave face such that, as the rotor turns, the vane is free to rotate about the pivot axis between a first position in which the vane defines a high-drag configuration for retreating with a transverse fluid flow, and a second position in which the vane defines a reduced-drag configuration for advancing against the transverse fluid flow.

2. The vane assembly of claim 1 wherein the concavo-convex part is developable, the pivot axis is inclined at a first angle to a straight line on the concave face; the pivot axis and the straight line lie in a pivot axis plane that makes a dihedral angle of 15° or less, with an axial-tangential plane of the rotor that rotates with the vane about the axis of rotation, and both the first angle and a second angle between the pivot axis and the axis of rotation are between 30° and 60°.

3. The vane assembly of claim 2 wherein: the dihedral angle is substantially 0°; both the first angle and the second angle are substantially 45°; the straight line is substantially parallel and perpendicular to the axis of rotation in the first and second positions respectively; and the vane is free to rotate substantially 180° about the pivot axis between the first and second positions.

4. The vane assembly of claim 3 wherein the vane is free to rotate 360° about the pivot axis.

5. The vane assembly of claim 4 wherein the axis of rotation is substantially upright, a leading end of the pivot axis is above a trailing end of the pivot axis; and in the first position the vane hangs below the pivot axis.

6. The vane assembly of claim 1, wherein the rotor comprises a hub defining the axis of rotation; and the pivot is offset from the hub.

7. The vane assembly of claim 1, wherein the concavo-convex part comprises at least one right half-cylinder having a cylindrical portion axis disposed in the pivot axis plane; wherein the vane has a substantially reflective symmetry about the pivot axis plane.

8. The vane assembly of claim 1, wherein the pivot axis intersects or passes proximate an axial end of the concavo-convex part.

9. The vane assembly of claim 1, wherein the vane further comprises at least one substantially flat fin portion aligned generally parallel with the pivot axis plane; the at least one fin portion projecting from the concave and/or the convex face of the concavo-convex part of the vane.

10. The vane assembly of claim 9 wherein the at least one fin portion projecting from the convex surface of an outermost one of the cylindrical portions is pointed.

11. The vane assembly of claim 9, wherein the at least one fin portion forms a spine of the vane that extends parallel to the pivot axis.

12. The vane assembly of claim 1, wherein the vane further comprises a counterweight having a centre of mass generally disposed in the pivot axis plane on an opposite side of the pivot axis to a centre of mass of the vane.

13. The vane assembly of claim 1, wherein the vane comprises a plurality of concavo-convex parts, each of the concavo-convex parts are of like form and are arrayed symmetrically about the pivot axis plane in one or more parallel linear rows, wherein the straight lines on each concave face of each concavo-convex part are substantially parallel to each other.

14. The vane assembly of claim 13 wherein the spacing along the pivot axis between adjacent concavo-convex parts is substantially equal.

15. The vane assembly of claim 1, wherein the rotor comprises two rotor rings of like diameter, coaxial with the axis of rotation and fixed to one another at axially spaced positions and wherein the pivot comprises a pivot shaft that extends between the rotor rings.

16. A propulsion device for a fluid-driven apparatus, the propulsion device comprising:
at least one vane with at least one concavo-convex part having a concave face and an opposing convex face;
a pivot having a pivot axis inclined to the concave face such that the vane is free to rotate about the pivot axis; and
a mount on the fluid-driven apparatus to which the vane is attached by the pivot such that the pivot axis is inclined at an acute angle to an upright, and the vane is free to rotate about the pivot axis between a first position, in which a straight line on the concave face is substantially upright, and a second position, in which the straight line is substantially horizontal.

17. The propulsion device of claim 16 wherein the concavo-convex part is developable, the pivot axis is fixed relative to the fluid-driven apparatus, a first angle exists between the pivot axis and a straight line on the concave face; the pivot axis and the straight line lie in a pivot axis plane that makes a dihedral angle of 15° or less, with an upright plane, and both the first angle and a second angle between the pivot axis and the upright are between 30° and 60°.

18. The propulsion device of claim 17 wherein the dihedral angle is substantially 0°; both the first angle and the second angle are substantially 45°; and the vane is free to rotate substantially 360° about the pivot axis.

19. The propulsion device of claim 16, wherein the fluid-driven apparatus comprises a wind-driven apparatus, such as a floating watercraft or a wheeled vehicle, and the pivot axis plane is aligned longitudinally, and the pivot axis rises toward the forward end.
